(19) United States
(12) Patent Application Publication
(10) Pub. No.: US 2015/0235741 A1
(43) Pub. Date: Aug. 20, 2015

(54) Noise Suppression Cable

(71) Applicant: Hitachi Metals, Ltd., Tokyo (JP)

(72) Inventors: Yosuke Sumi, Hitachinaka (JP); Naofumi Chiwata, Mito (JP); Katsuya Akimoto, Hitachi (JP); Katsutoshi Nakatani, Hitachi (JP); Kenji Ajima, Hitachiota (JP); Hiroshi Okikawa, Hitachi (JP); Yasuharu Muto, Kitaibaraki (JP)

(21) Appl. No.: 14/606,826

(22) Filed: Jan. 27, 2015

(30) Foreign Application Priority Data
Feb. 19, 2014 (JP) 2014-029738

(51) Int. Cl. H01B 11/10; H01B 3/30; H01B 7/02

(52) U.S. Cl. CPC H01B 11/1083; H01B 7/0275; H01B 3/30; H01B 7/0241

(57) ABSTRACT

A noise suppression cable includes a conductor wire, and a magnetic insulation layer that is formed around the conductor wire and includes an insulating material and a flat-shaped magnetic powder. A flatness direction of the magnetic powder is oriented in a circumferential direction of the magnetic insulation layer.

The present application is based on Japanese patent application No. 2014-029738 filed on Feb. 19, 2014, the entire contents of which are incorporated herein by reference.

### BACKGROUND OF THE INVENTION

1. Field of the Invention

The invention relates to a noise suppression cable to suppress electromagnetic wave noise emitted from the cable.

2. Description of the Related Art

A noise suppression cable is known in which magnetic powder is mixed in a cable sheath instead of disposing a ferrite core around the cable (see e.g. JP-A-2004-158328).

The noise suppression cable is constructed such that an insulated wire formed by covering a conductor with an insulation is sequentially covered with a shielding and a sheath layer. The sheath layer includes a magnetic powder-mixed-resin layer formed of a mixture of a resin and a magnetic powder, and the mixture ratio of the magnetic powder to the resin in the magnetic powder-mixed-resin layer is 30 to 70 vol %. This allows the suppression of electromagnetic wave noise in a wideband frequency range of about 1 kHz to 1 GHz.

### SUMMARY OF THE INVENTION

The noise suppression cable sometimes may fail to sufficiently suppress the electromagnetic wave noise emitted from the cable depending on the mixture ratio of the magnetic powder.

It is an object of the invention to provide a noise suppression cable that improves the suppression effect of the electromagnetic wave noise emitted from the cable as compared to the conventional noise suppression cable.

(1) According to one embodiment of the invention, a noise suppression cable comprises:

a conductor wire; and

a magnetic insulation layer that is formed around the conductor wire and comprises an insulating material and a flat-shaped magnetic powder,

wherein a flatness direction of the magnetic powder is oriented in a circumferential direction of the magnetic insulation layer.

In the above embodiment (1) of the invention, the following modifications and changes can be made.

(i) The flatness direction of the magnetic powder is oriented so as to be not less than 0° and not more than 30° with respect to the circumferential direction.

(ii) The magnetic powder and the insulating material are mixed in a ratio of 5 vol % to 60 vol %.

(iii) The magnetic powder is not less than 2 and not more than 50 in a flatness ratio of a maximum length and a thickness thereof.

(iv) The insulating material comprises a resin, and wherein the magnetic insulation layer is formed by extrusion molding.

(2) According to another embodiment of the invention, a noise suppression cable comprises:

an insulated wire comprises a conductor wire and an insulation formed around the conductor wire;

a shield layer formed around the insulated wire; and

a magnetic insulation layer that is formed around the shield layer and comprises an insulating material and a flat-shaped magnetic powder,

wherein a flatness direction of the magnetic powder is oriented in a circumferential direction of the magnetic insulation layer.

### Effects of the Invention

According to one embodiment of the invention, a noise suppression cable can be provided that improves the suppression effect of the electromagnetic wave noise emitted from the cable as compared to the conventional noise suppression cable.

### BRIEF DESCRIPTION OF THE DRAWINGS

Next, the present invention will be explained in more detail in conjunction with appended drawings, wherein:

FIG. 1 is a perspective view showing a general configuration of a noise suppression cable in an embodiment of the present invention;

FIG. 2 is a cross sectional view showing the noise suppression cable shown in FIG. 1;

FIG. 3 is a cross sectional view showing a main portion of a magnetic insulation layer along a cable longitudinal direction; and

FIG. 4 is a graph showing an emission noise suppression effect in Example of the invention.

### DETAILED DESCRIPTION OF THE PREFERRED EMBODIMENT

An embodiment of the invention will be described below in reference to the drawings. It should be noted that constituent elements having substantially the same functions are denoted by the same reference numerals in each drawing and the overlapping explanation thereof will be omitted.

### Embodiment

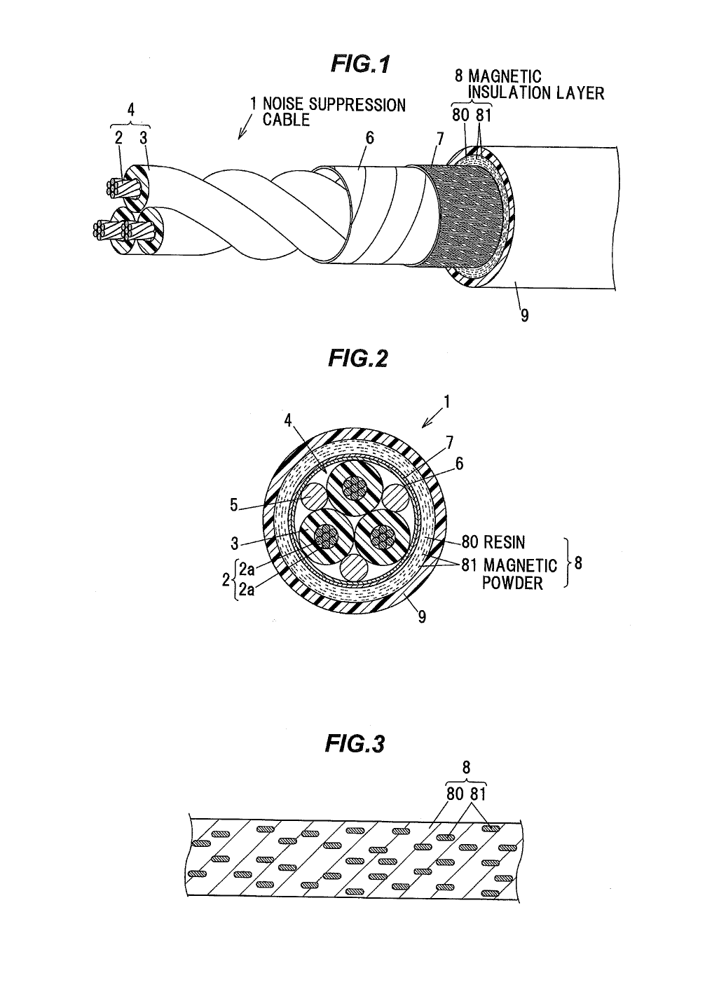

FIG. 1 is a perspective view showing a general configuration of a noise suppression cable in the embodiment of the invention. FIG. 2 is a cross sectional view showing the noise suppression cable shown in FIG. 1. FIG. 3 is a cross sectional view showing a main portion of a magnetic insulation layer along a cable longitudinal direction. The illustration of inclusions 5 is omitted in FIG. 1.

A noise suppression cable 1 is provided with plural insulated wires 4 (three in the present embodiment) each formed by covering a conductor wire 2 with an insulation 3, a resin tape layer 6 wound around the plural insulated wires 4 with inclusions 5 interposed therebetween, a shield layer 7 provided around the resin tape layer 6, a magnetic insulation layer 8 provided around the shield layer 7 and a sheath 9 as an insulating protective layer formed of a resin, etc., and provided around the magnetic insulation layer 8.

The conductor wire 2 is formed by twisting plural thin metal wires 2a (seven in the present embodiment) together. The insulated wire 4 transmits a signal of, e.g., 1 MHz to 10 GHz. The number of the insulated wires 4 is more than one in the present embodiment but may be one. In addition, the insulated wire 4 may be a twisted wire pair which transmits differential signals.

The resin tape layer 6 is formed by, e.g., winding a resin tape around the plural insulated wires 4 with the inclusions 5 interposed therebetween throughout a longitudinal direction of the cable. As the rein tape, it is possible to use, e.g., a tape formed of a resin such as polyethylene terephthalate (PET) or polypropylene-based resin, etc.

The shield layer 7 is formed by braiding conductive wires and is connected to a ground. Alternatively, the shield layer 7 may be formed by winding a tape with a conductor attached thereto.

Configuration of Magnetic Insulation Layer

The magnetic insulation layer 8 is formed of a mixture of a resin 80 as an insulating material and a flat-shaped magnetic powder 81. In case of using the magnetic powder 81 of substantially disc shape, extrusion-molding the mixture of the resin 80 and the magnetic powder 81 causes a flatness direction (an in-plane direction) of the magnetic powder 81 to be oriented along the longitudinal direction (extrusion direction) and the circumferential direction of the cable. In other words, the magnetic powder 81 is substantially parallel to the cable longitudinal direction as well as to the circumferential direction. The magnetic insulation layer 8 has a circular cross section in the present embodiment but may have an oval cross section or a quasi-oval cross section.

A mixture ratio of the magnetic powder 81 to the resin 80 is exemplarily 5 to 60 vol %, more exemplarily 10 to 40 vol % in terms of both flexibility of cable and electromagnetic wave noise suppression effect.

Configuration of Resin

As the base resin 80, it is possible to use, e.g., vinyl chloride resin, ethylene vinyl acetate polymer, fluorine-based resin and silicone-based resin, etc. In addition, the resin 80 is exemplarily crystalline rather than amorphous for orienting the flatness direction of the magnetic powder 81 along the cable longitudinal direction and the circumferential direction.

Configuration of Magnetic Powder

The orientation direction of the magnetic powder 81 is exemplarily not less than 0° and not more than 30° with respect to the circumferential direction. In the present embodiment, the magnetic powder 81 is flattened into a substantially disc shape or a substantially plate shape. When the flatness ratio of the magnetic powder 81 derived by the maximum length/thickness is less than 2, it is difficult to obtain a desired relative magnetic permeability. On the other hand, when the flatness ratio is more than 50, the magnetic powder 81 is highly likely to be damaged during molding of the magnetic insulation layer 8. Therefore, the flatness ratio of the magnetic powder 81 is exemplarily not less than 2 and not more than 50, more exemplarily, not less than 10 and not more than 50. The minimum diameter of the magnetic powder 81 is exemplarily not less than 1 μm and not more than 20 μm. All of the magnetic powder 81 does not need to satisfy the above-mentioned flatness ratio and it may be such that not less than 80% of the magnetic powder 81 satisfies the above-mentioned flatness ratio and the remaining has the flatness ratio of less than 2.

The magnetic powder 81 is exemplarily formed of a soft magnetic material with a small coercive force and high magnetic permeability in order to suppress electromagnetic wave noise. As the soft magnetic material, it is possible to use, e.g., ferrite powder such as Mn—Zn ferrite powder, Ni—Zn ferrite powder or Ni—Zn—Cu ferrite powder, and soft magnetic metal powder such as Fe—Ni alloy (permalloy), Fe—Si—Al alloy (sendust alloy) or Fe—Si alloy (silicon steel).

The sheath 9 is formed of, e.g., the same resin as the resin 80 which is used as a base of the magnetic insulation layer 8. A cover layer covering the shield layer 7 is formed to have a two-layer structure composed of the magnetic insulation layer 8 and the sheath 9, thereby adding more mechanical strength. Here, considering adhesion between the magnetic insulation layer 8 and the sheath 9 at an interfacial boundary, the magnetic insulation layer 8 and the sheath 9 may be simultaneously extruded to cover the outer periphery of the shield layer 7.

### Functions and Effects of the Embodiment

The following functions and effects are obtained in the embodiment.

(1) By orienting the flatness direction of the flat-shaped magnetic powder 81 along the circumferential direction, impedance is increased as compared to the case of using granular magnetic powder mixed at the same ratio as that in the present embodiment. This allows electromagnetic wave noise (emission noise) emitted from the cable to be suppressed more effectively.

(2) It is possible to reduce the amount of magnetic powder for obtaining an electromagnetic wave noise suppression effect equivalent to that in the case of using granular magnetic powder.

(3) A ferrite core is not used. Therefore, an appearance is better, problems during handling such as cracks on the ferrite core do not arise, and it is possible to suppress electromagnetic wave noise emission without increasing an outer diameter of the cable.

### Example

The noise suppression cable 1 used in Example was made as follows: the sheath 9 of a LAN cable (NETSTAR (registered trademark) manufactured by Hitachi Metals, Ltd., C6/8 24AWG×4P, CAT6) was removed and the magnetic insulation layer 8 was extruded and formed around the shield layer 7. The magnetic insulation layer 8 was configured such that a mixture ratio of magnetic powder (pulverized powder of FINEMET (registered trademark) manufactured by Hitachi Metals, Ltd.) to an olefin-based resin (TAFMER (registered trademark) DF470 manufactured by Mitsui Chemicals, Inc.) was 40 vol % and the flatness direction of the magnetic powder 81 was oriented along a circumferential direction of the cable.

A LAN cable which is basically the same as that in Example but does not have the magnetic insulation layer was used as Comparative Example. In Example and Comparative Example, the magnetic near-field was measured by an EMI tester (EMV-200 manufactured by Peritec Inc.).

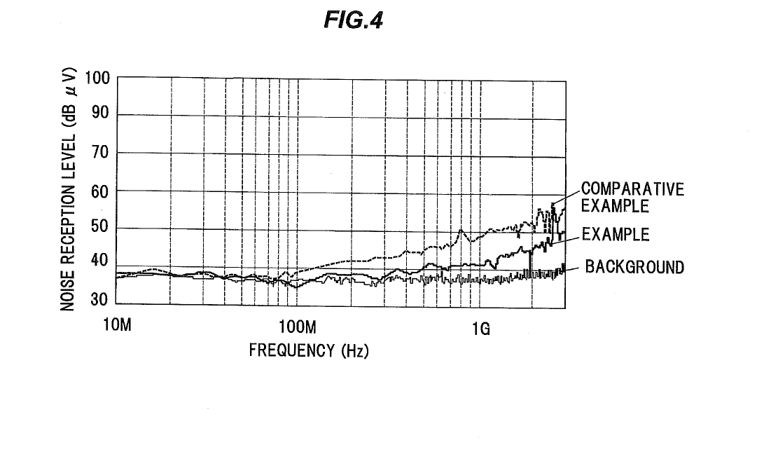

FIG. 4 is a graph showing an emission noise suppression effect in Example of the invention. It is understood from FIG. 4 that emission noise was reduced by, e.g., about 7 dB (μV) at a frequency of 1 GHz.

It should be noted that embodiments of the invention are not limited to that described above and various kinds of embodiments can be implemented. For example, an insulating material of the magnetic insulation layer may be a rubber instead of the resin. As the rubber, it is possible to use natural rubbers or synthetic rubbers such as chloroprene rubber, polybutadiene rubber, polyisoprene rubber, ethylene-propylene rubber, acrylonitrile-butadiene rubber, isobutylene-isopropylene rubber and styrene-butadiene rubber, etc.

In addition, some of the constituent elements in the embodiment can be omitted or changed without changing the gist of the invention. For example, the inclusion 5 may be omitted as long as no problem arises when winding a resin tape around the plural insulated wires 4.

In the present embodiment, the magnetic insulation layer 8 formed around the shield layer 7 has been explained as an insulation layer formed around a conductor wire. However, instead of using the magnetic insulation layer 8 or together with the magnetic insulation layer 8, the insulation 3 covering the conductor wire 2 may include the flat-shaped magnetic powder which is mixed so that a longitudinal direction is oriented along the circumferential direction. In addition, the shape of the magnetic powder 81 is the substantially disc shape or the substantially plate shape in the embodiment but may be a fibrous shape, etc.

What is claimed is:

1. A noise suppression cable, comprising:
a conductor wire; and
a magnetic insulation layer that is formed around the conductor wire and comprises an insulating material and a flat-shaped magnetic powder,
wherein a flatness direction of the magnetic powder is oriented in a circumferential direction of the magnetic insulation layer.

2. The noise suppression cable according to claim 1, wherein the flatness direction of the magnetic powder is oriented so as to be not less than 0° and not more than 30° with respect to the circumferential direction.

3. The noise suppression cable according to claim 1, wherein the magnetic powder and the insulating material are mixed in a ratio of 5 vol % to 60 vol %.

4. The noise suppression cable according to claim 1, wherein the magnetic powder is not less than 2 and not more than 50 in a flatness ratio of a maximum length and a thickness thereof.

5. The noise suppression cable according to claim 1, wherein the insulating material comprises a resin, and
wherein the magnetic insulation layer is formed by extrusion molding.

6. A noise suppression cable, comprising:
an insulated wire comprises a conductor wire and an insulation formed around the conductor wire;
a shield layer formed around the insulated wire; and
a magnetic insulation layer that is formed around the shield layer and comprises an insulating material and a flat-shaped magnetic powder,
wherein a flatness direction of the magnetic powder is oriented in a circumferential direction of the magnetic insulation layer.
